(19) United States
(12) Patent Application Publication
(10) Pub. No.: US 2013/0001490 A1
(43) Pub. Date: Jan. 3, 2013

(54) Apparatus for Retracting, Storing and Inserting an Elongated Element

(75) Inventors: Gerard Plumettaz, Territet-Veyraux (CH); Willem Griffioen, Ter Aar (NL); Patrice Blanchet, Leytron (CH)

(73) Assignee: Plumettaz Holding S.A., Bex (CH)

(21) Appl. No.: 13/511,033

(22) PCT Filed: Oct. 22, 2010
(86) PCT No.: PCT/EP2010/066001

§ 371 Date: Aug. 8, 2012

(30) Foreign Application Priority Data
Nov. 23, 2009 (CH) 01795/09

(51) Int. Cl. B66D 3/04

(52) U.S. Cl. 254/389

(57) ABSTRACT

An apparatus retracts, stores, and inserts an elongated element. The apparatus has a retracting unit for retracting a length of a pre-cut module through a window of a retractable cable, a storage unit for storing the retracted pre-cut module, and an inserting unit for inserting the retracted pre-cut module into a branch duct. The retracting unit, the storage unit, and the inserting unit are mounted on an assembly portion installed at a branch location.

### TECHNICAL FIELD

The disclosure concerns a simple tool that pulls a length of pre-cut (at a downstream location) module (per example optical) out of a retractable cable (which contains a loose bundle of said modules), stores it in a container, and pushes and/or blows it back into a branch duct.

Such tool can be favorably used for the establishment of a derivation in T or Y from a principal line, without necessity of any junction box or splice.

### BACKGROUND

A typical device includes a retractable cable, with inside it's jacket a loose bundle of fiber modules, and a method to access said modules for branching has been described. For this at 2 places a window is made in the cable jacket. At one place (downstream) the module(s) of choice is (are) cut and at the other place (upstream), the branching location, said module(s) is (are) retracted from the cable. After that pulling into branch ducts can be done, enabling the final drop installed, the customer connection, without making a splice.

The retracting procedure today is as follows. After the windows in the cable are made and the module of choice has been cut, said module is gripped by tweezers at the branch window. Optionally first a tapping box was already placed, but, that can also been done at a later stage. When the module of choice has been accessed it is first gently pulled out in a loop. Then the rest of the length is pulled out by hand. The pulled out module is dropped on the floor, or wound on a Figure-8 table by another operator, depending of the situation (e.g. pulling length). Pulling lengths are typically up to 25 m for indoor riser cables and up to 300 m for outside plant fiber to the home networks. Next step, pulling the fiber module through the branch duct also requires at least 2 operators, one for guiding and optionally unwinding from the Figure-8 table, and one for pulling. The latter is sometimes also done by 2 men, when hard pulling is required and the branch duct must also be held by a man. The following disadvantages have been encountered:
The process is a time consuming operation with at least 2 operators.
The operation can result in a mess.
A pulling chord must be pre-installed in the branch duct.
Pulling the module into the branch duct needs high pulling forces, and a risk for fiber break.
Hand pushing, from the branch location into the branch duct, is even worse. Soon, when the pushing force becomes high, the “free stroke” (the length over which pushing can be done without buckling the module) becomes short, the process will be very time consuming and there will be a big risk for kinking (man dependent).
When a break occurs, the whole retractable cable must be replaced. If not, spare capacity must have been reserved for unintended breaks. As the latter is very much man-dependent such planning will be extremely unpractical.

Generally, a plurality of cables is blown first into a first duct, to a branching location. From there the individual cable can be blown into separate (branching) ducts. The end product looks like the end product from the above mentioned method, but the way to install this network is completely different. In addition, this method does not store the cables halfway through the process.

### SUMMARY

An apparatus retracts, stores, and inserts an elongated element. The apparatus has a retracting unit for retracting a length of a pre-cut module through a window of a retractable cable, a storage unit for storing the retracted pre-cut module, and an inserting unit for inserting the retracted pre-cut module into a branch duct. The retracting unit, the storage unit, and the inserting unit are mounted on an assembly portion installed at a branch location.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows the complete tool, placed in the tapping box,

FIG. 2 shows the bottom part of the tool. This part is placed first in the tapping box,

FIG. 3 shows the bottom part of the part from FIG. 2, without tapping box, retractable cable and branch duct,

FIG. 4 shows the same as FIG. 2, but with a first module already retracted from the retractable cable and inserted into the branch duct,

FIG. 5 shows the total tool, but without container, motor and counter, after placing of the top part on the bottom part and mounting said upper part on the tapping box,

FIG. 6 shows starting of the retraction process of the second module, with the first loop of the module taken out. The middle wheel is the drive wheel. Note the 180° capstan,

FIG. 7 shows the end of the retraction process. The last piece of the module is gripped by a plastic ball, activated by the top pressure wheel when the module has left between drive wheel and top pressure wheel,

FIG. 8 shows the process close to the end of pushing the module into the branch duct. The plastic ball might untwist the last torsion,

FIG. 9 shows another view of a part of the tool,

FIG. 10 shows the module entirely pushed into the branch duct. For indoor use the wheels can be placed a little more to the left and no need for this long guide channel, making short free branch lengths possible,

FIG. 11 shows an exemplary funnel,

FIG. 12 shows a device disposed inside the funnel,

FIGS. 13A, 13B and 13C show another device disposed inside the funnel and two cuts of said device,

FIG. 14 shows a cut of the container equipped with a device fort properly disposing the module inside the container,

FIGS. 15A and 15B show a container and a view of another device for properly disposing the module inside the container,

FIG. 16 shows another variant of the container, and

FIG. 17 sows a detailed view of a spinning arm.

### DETAILED DESCRIPTION

In the present invention a tool to retract a module from a retractable cable, store it and feed it into a branch tube is used. A preferred embodiment of this tool has been developed around a tapping box with non-dividable branching ports. Also retracting of multiple modules, also fed into a single branch tube is possible in this embodiment. A second embodiment is possible that can be used in general for tapping boxes with dividable branch ports. It can be designed from the first embodiment by skipping a few elements and slightly modifying some details. Such an embodiment is not further shown.

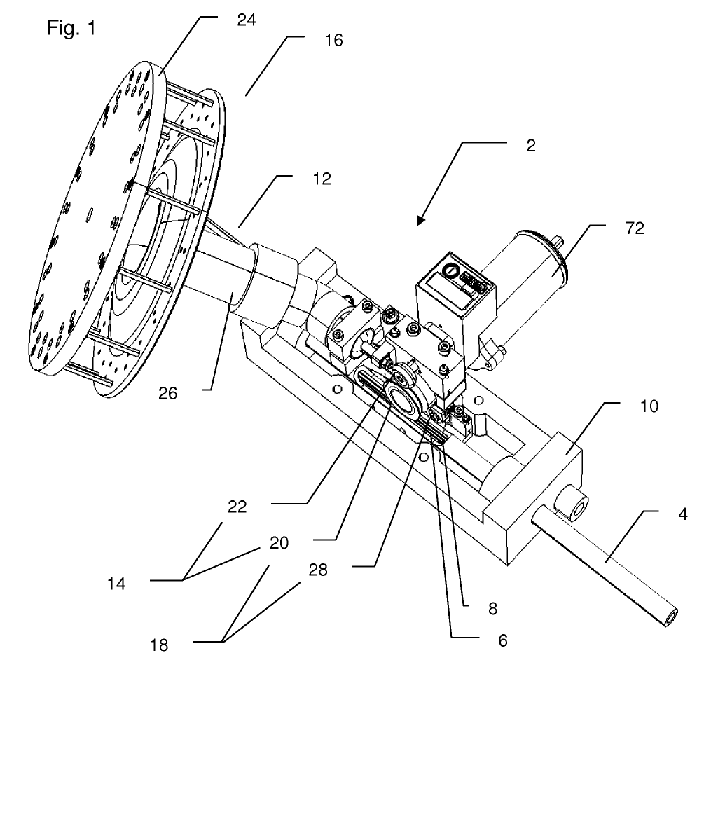

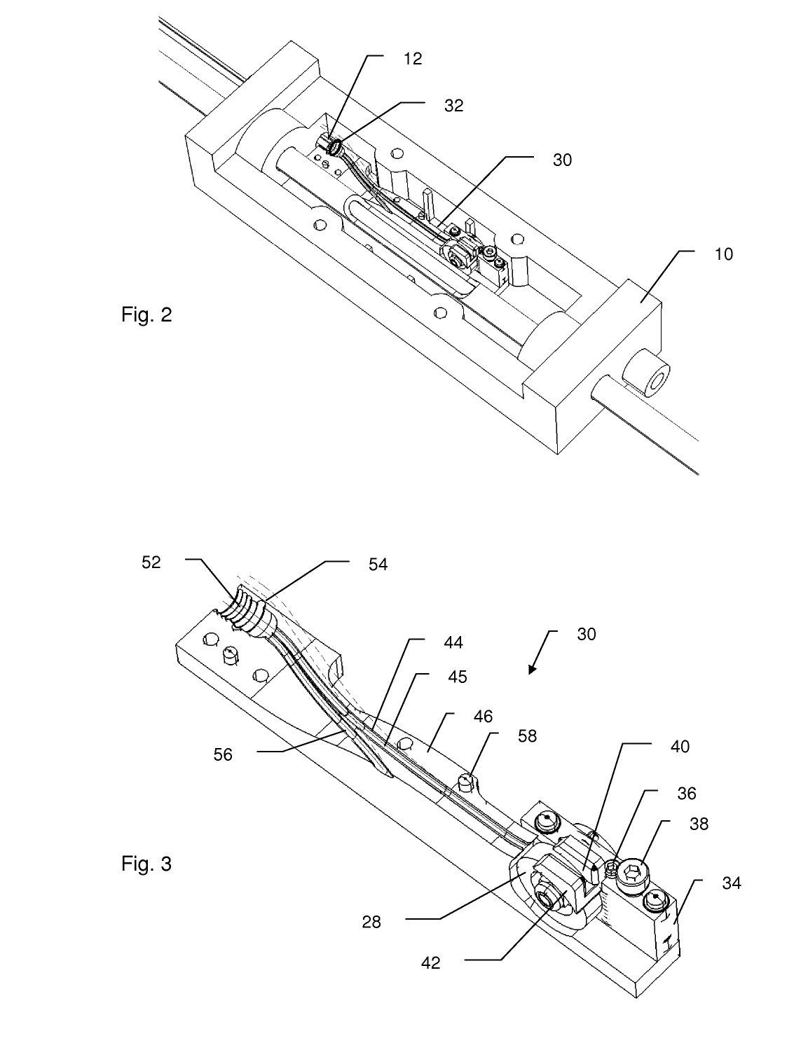

In FIG. 1 the complete tool 2 is shown. A retractable cable 4 containing a number of modules 6 is also shown. At two different positions in said retractable cable, windows are made to access the modules, at least one at a branch length downstream (not shown) and one, window 8, at the branch location. A tapping box 10 is mounted around the retractable cable 4 at the branch location, such that window 8 is placed inside said tapping box. In tapping box 10 also a branch duct 12 is mounted, (see FIG. 2) The tool 2 is mounted on the tapping box 10. The tool consists of pull-out means 14, storing means 16 and inserting means 18. The module 6 is pulled out by the drive wheel 20 and upper press wheel 22. Storing is done in the container 24 that is connected by funnel 26. Inserting is done by the same drive wheel 20 and the lower press wheel 28.

In FIG. 2 a first step of mounting the tool is shown. Before mounting the entire tool, first the bottom part 30 is placed in tapping box 10. Said bottom part is placed under the branch duct 12 with an O-ring 32 already in place.

In FIG. 3 the bottom part 30 of the tool is shown in more detail, without tapping box 10, retractable cable 4 and branch duct 12. Bottom part 30 consists of a lower press wheel 28 that is spring (not shown) loaded via holding block 34 against drive wheel 20 (not shown, is part of upper part, see FIG. 5). The spring load can be adjusted by bolt 36 (not visible). With bolt 38 the lower press wheel can be released from the drive wheel. The module is first guided (to the right axial position of the lower drive wheel) by a slit 40 in guiding block 42. Immediately after the module has passed the lower press wheel 28 and the drive wheel said module is guided through a channel 44, formed by a slit 45 in block 46. The “ceiling” of channel 44 is formed by block 48, which is a part of the upper part 50 of the tool (not shown in FIG. 3). In block 46 also the branch duct can be clamped, by teethed portion 52, and sealed, by O-ring 32 that is placed in groove 54 of block 46. Another channel 56 is made in block 46. Here a previously installed module can be placed. With pins 58 the upper part is positioned on the lower part of the tool.

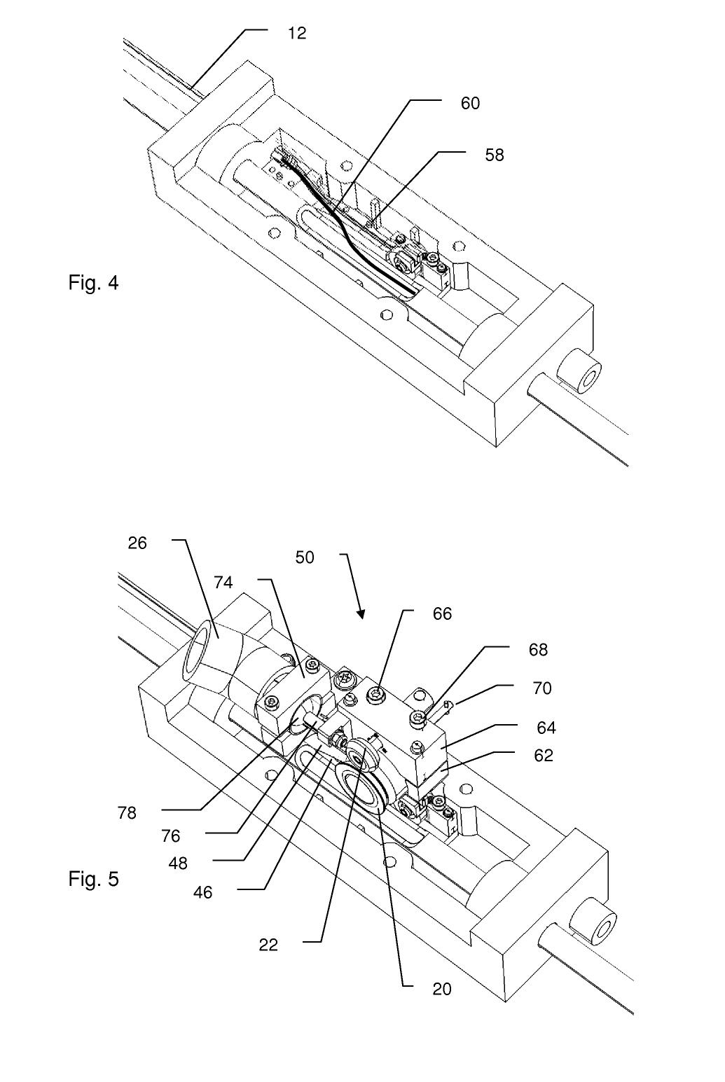

In FIG. 4 a previously installed module 60 is shown, now with retractable cable 4 and branch duct 12 shown again.

In FIG. 5 the upper part 50 of the tool has been placed. Here block 48 can be recognized that matches with block 46. Upper part 50 also contains drive wheel 20, mounted in holding block 62, and upper press wheel 22, mounted in holding block 64. The upper press wheel is also spring (not shown) loaded. The spring can be adjusted by bolt 66 and with bolt 68 the upper press wheel can be released from the drive wheel. A motor can be connected to axes 70 of the drive wheel. In this embodiment a magnetic clutch 72 (see FIG. 1) is used onto which a cordless screwdriver/boring tool (not shown) can be connected, optionally via a flexible shaft (also not shown). Onto block 48 is also mounted a clamping device 74 that holds the funnel 26 of the storing means 16 (not represented here). Connected to holding block 64 is, via crank 76, a spherical ball body 78. The space between the bottom of spherical ball body 78 and the inside of funnel 26 is just enough to let module 6 pass. When module 6 is entirely pulled out of retractable cable 4 and leaves the space between the drive wheel and the upper press wheel, the latter moves down a little, activated by the spring load. Body 78 moves down with the upper press wheel such that the space between the bottom of body 78 and the inside of funnel 26 becomes less than the diameter of module 6, resulting in holding module 6, preventing said module from being lost in the container 24.

The figure shows 5 an example of assembly portion comprising the bottom part 30 and the upper part 50 of the tool 2 on which are fixed the retracting means 20, 22, the storing means 26 and the inserting means 20, 28.

The tool can be driven e.g. by its own motor and control or by a cordless screwdriver/boring tool, optionally connected by a flexible shaft connected to axes 70.

The force in pulling must be high (typically 10-25 N, preferably 15 N) to obtain long enough pulling lengths. For this just gripping the module between 2 wheels is not sufficient. For this reason pulling out is done either by using caterpillars or, more simple (preferred), by using a capstan. In the latter case the drive wheel can serve as a capstan, see further.

The pushing force must be much lower than the pulling force (typically 2-5 N, preferably 3 N). For this reason a magnetic clutch is used. Also the module must be guided through narrow channels after pushing, to prevent kinking of the module. For longer length, assistance of a high-speed airflow is used. In US 20090236575 a tool has been described that uses such a magnetic clutch, has the possibility of air-assistance and is provided with anti-buckling guide channels. In such a device the required pushing force of up to 5 N can easily be reached without using a capstan. In a preferred embodiment the drive wheel direction in the pushing mode is opposite of that in the pulling mode, allowing simple and fool-proof switching between the different required forces. It is possible to use a magnetic clutch in the push direction and none in the pull direction. It is also possible to use clutches of different (preferably fixed) values in both directions. In case the motor has its own motor and control the latter can take care of the different forces in both directions.

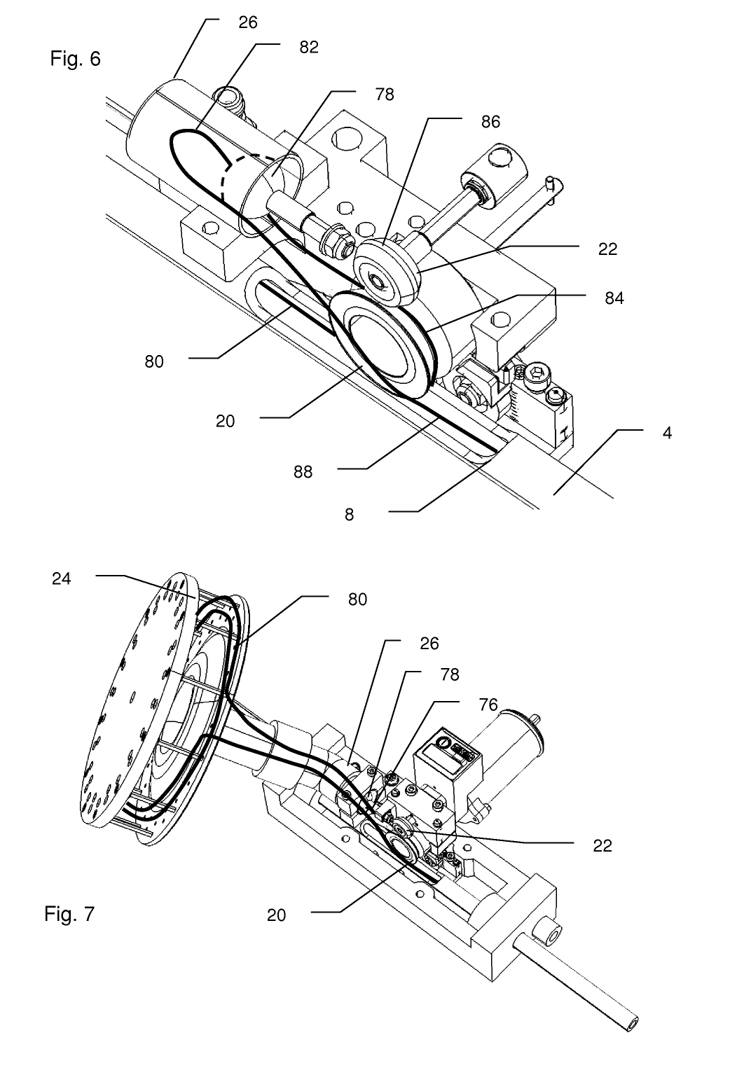

FIG. 6 shows starting of the actual retraction process of the second module 80. First a loop 82 of module 80 is taken out of the window 8 in retractable cable 4, e.g. by using tweezers. Next said module is wound around drive wheel 20, guided under upper press wheel 22 and said loop inserted into the entrance of funnel 26 (shown transparently, for clarity; also not all parts shown). Note the 180° capstan around the drive wheel 20. This results in extra pulling force. If the pulling force at the location between drive wheel 20 and upper press wheel 22 is Fi, then the pulling force F₂ (at window 8) is given by (see W. Griffioen, “Installation of optical cables in ducts”, Plumettaz, Bex, Switzerland, 1993):

F₂=F₁.exp(fπ)

Here f is the coefficient of friction between module 80 and drive wheel 20. The ratio F₂ 1 Fi is given below for a number of coefficients of frictions f:

| f | 0.1 | 0.2 | 0.5 | 1 |
|---|---|---|---|---|
| F₂/F₁ | 1.4 | 1.9 | 4.8 | 23.1 |

The coefficient of friction between module 80 and drive wheel 20 may vary between 0.1 for lubricated plastic modules around steel drive wheels until more than 1 for non-lubricated plastic modules around rubber drive wheels. For a preferred embodiment with slightly lubricated (to enhance pulling out of the module out of the retractable cable) plastic modules around e.g. Linatex® or Nyoprene® rubber drive wheels the coefficient is around 0.5. In this case already around a factor of 5 more pulling force can be obtained than just by pressing the upper press wheel 22 onto drive wheel 20. The invention is not limited to these materials, nor to a capstan of 180°.

In order to keep the module 80 around drive wheel 20 the latter has been accommodated with a U-groove 84, matching with a convex edge 86 of upper press wheel 22. The static part 88 of module 80 is parked “behind” the wheels 20 and 22. The loop 82 of module 80 had passed the space between funnel 26 and spherical ball body 78.

FIG. 7 shows the end of the retraction process. Here the full length of the retracted module 80 has been pulled out and stored in the container 24. When the module is pulled away from drive wheel 20 and leaves the space between said drive wheel and upper press wheel 22, the spring action of said press wheel causes said press wheel to move down to said drive wheel. At the same time the spherical ball body 78, this is in communication (via crank 76) with upper press wheel 22, moves down. This action causes to brake module 80, which is then clamped between the spherical ball body 78 and funnel 26 (for this reason the spherical ball body 78 is preferably made out of rubber-like material). This prevent module 80 from being shot (or falling) too far into the funnel, which would make the module 80 inaccessible for further processing.

Different devices for storing cables in containers are known. One example is described in U.S. Pat. No. 5,699,974. Here an optical fiber transmission line is coiled in a “rosette shape” into a circular container, using a special mechanism. In another example also coiling a cable in a circular basket is done, by means of a spinning arm, as described in U.S. Pat. No. 5,911,381. In the latter example all elements, including the arm, are developed “dividable”, i.e. such that a midspan section of the cable can be stored and retrieved without cutting the cable (note that none of these storing devices get their cable fed directly from pulling out). In the preferred embodiment of the present invention the use of such a spinning arm is considered to be too complicated (also it is not intended to make the “rosette shapes”). Therefore in the preferred embodiment containers are used where the modules can be inserted and retrieved without using spinning arms (however, embodiments with spinning arm might be needed for some types of module, and are also described). For this a special geometry was needed for the container, deviating from the geometry of known containers. Most characteristic (new) properties are the small height of the container and the use of a small diameter funnel for feeding the container. The diameter of the container is typically between 100 and 500 times that of the module, more specific between 150 and 300 times. The height of the container is typically between 10 and 60 times the diameter of the module, more specific between 10 and 40 times and even more specific between 10 and 20 times. The diameter of the funnel is typically between 10 and 40 mm, more specific between 10 and 20 mm. The length of the funnel is typically minimum 40 mm. Furthermore the ceiling and/or bottom of the container can be made conical (tapered). Finally also an easy to mount simple passive spinner is described that does not contain an arm.

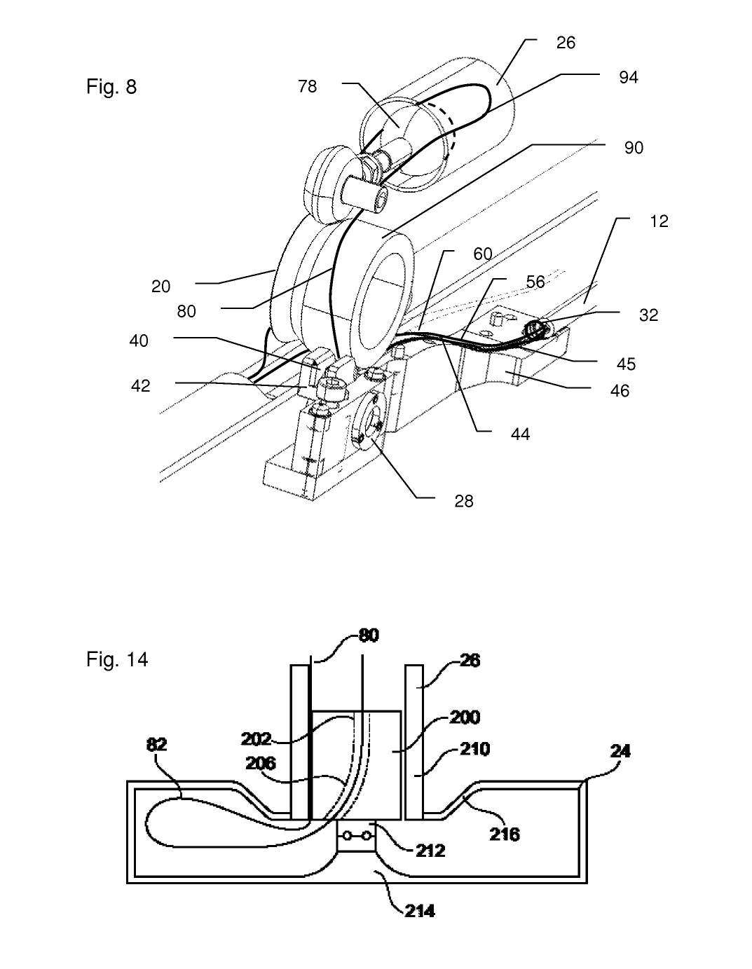

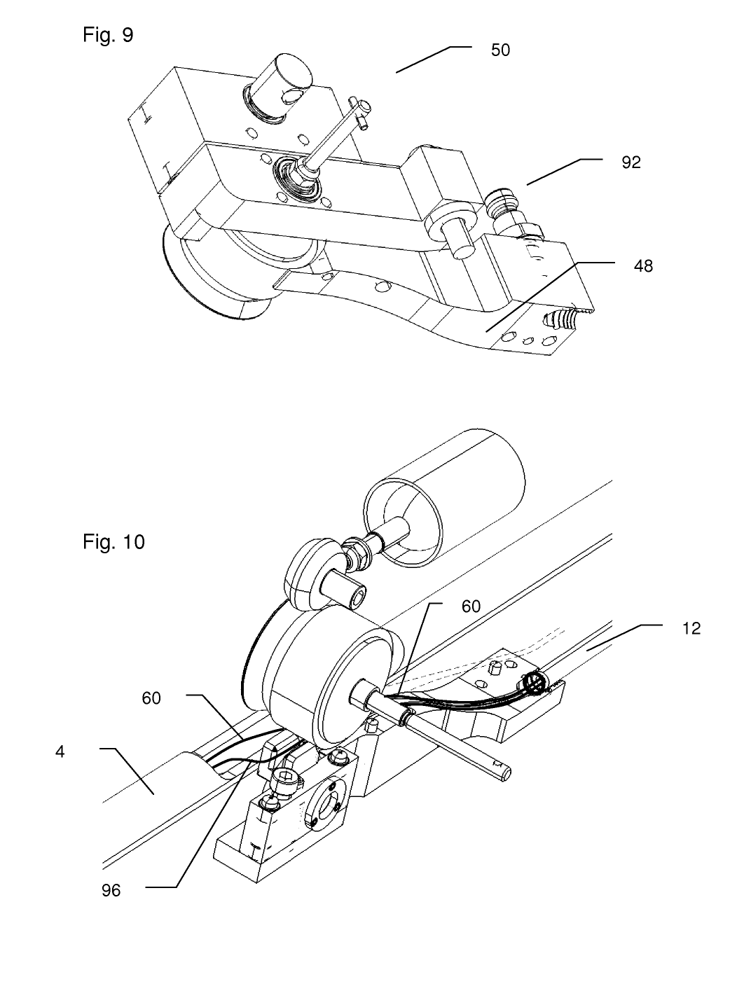

Next step is pushing the stored module 80 into branch duct 12. FIG. 8 shows the process close to the end of pushing said module into said branch duct. For clarity the tapping box is not shown, the funnel 26 is shown transparently and some parts of the upper part 50 of the tool are shown separately in FIG. 9. Now module 80 has been guided over another, neighboring (can be of different material, because no large pulling force required here), part 90 of drive wheel 20. Actual pushing is done at the place where the second lower press wheel 28 presses (again spring action not shown) said module against drive wheel 20. Module 80 is guided through channel 44. First the module passes a guiding block 42 with guiding slit 40, which brings the module in the position of channel 44. Then, when the module has passed the position where lower press wheel 28 presses against drive wheel part 90, the guiding channel 44 is confined at the bottom by the slit 45 in guiding block 46 (part of lower part 30 of the tool) and at the top by the (smooth) part 90 of drive wheel 20, against which said guiding block makes a close contact (small gap, just no friction). When the module continues, the confinement of guiding channel 44 at the top is taken over by block 48, a part of the upper part 50 of the tool (shown in FIG. 9). Note that at the entrance the slits in guiding blocks 42 and 46 are made a little rounded in order for the module to find its way without being stuck when pushed through. In guiding block 42 also the outside is rounded.

Further in the channel optionally a lipseal (also rounded entrance, lipseal not shown) makes an airtight seal when the module 80 has passed. From this moment on the channel can be pressurized with air, fed through inlet 92 (see FIG. 9). For this the upper and lower part of the guiding block are sealed airtight, e.g. by using O-rings (not shown, only the O-ring 32 that seals the branch duct 12 has been shown). A previously installed module 60 may also be present. The latter module has been bypassed in the guiding block 46 through channel 56. The spherical ball body 78 also serves to untwist a possible remaining torsion twist in the last section of the retracted loop 94 of module 80.

Finally the entire length of module 80 has been retrieved from the container. FIG. 10 shows the module entirely pushed into the branch duct 12. It then follows a close to a straight path 96 from retractable cable 4 to branch duct 12. After completion of all the modules (more modules like module 60 could have been previously installed and parked) the parts of the retractable tool can be removed.

Note that for indoor use a simpler tool can be made. Here the tapping box may be fully dividable, including the branch duct ports. A lot of elements can be taken out then. No guiding blocks 46 and 48 are needed. Instead lower press wheel 28 and a simple holder for the branch duct (but, with blowing facility!) are connected to the tool. It is intended to keep as many parts as possible the same for both indoor and outdoor applications, and supply the rest as adapters.

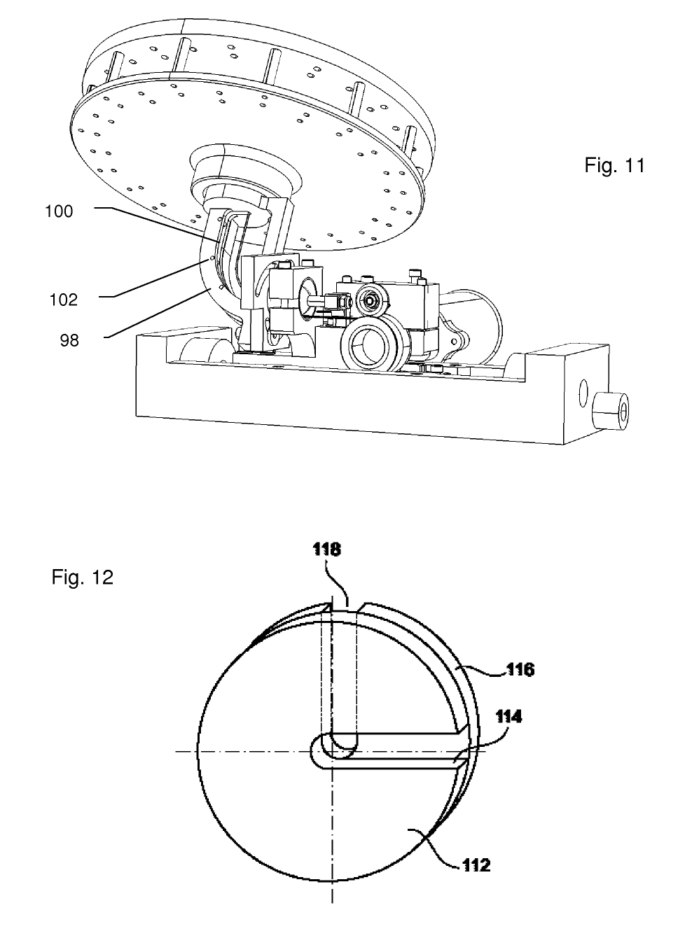

Sometimes, depending e.g. on the properties of the module, coiling of the module in the container changes spinning direction. This might cause tangling when uncoiling. In most cases this changing in direction can be avoided when the module is held in a confined geometry when going from funnel to container. This can be done e.g. by making a guiding slit at that location, like in FIG. 11 where in mounting block 98 a slit 100 has been cut. The holes 102 allow pins (not shown) to lock the module inside the slit once placed.

A central hole is another solution. A solution without the need to cut the module is found in using two circular plates, shown in FIG. 12. Here two circular plates are placed rotatable inside the funnel, close to the container. The first plate 112 contains a slit 114, the second plate 116 a slit 118. When the slits are in the same position the loop can pass. The slits become a centered hole when rotating one of the plates, e.g. by 90°. The plates 112, 116 are represented transparent in the figure.

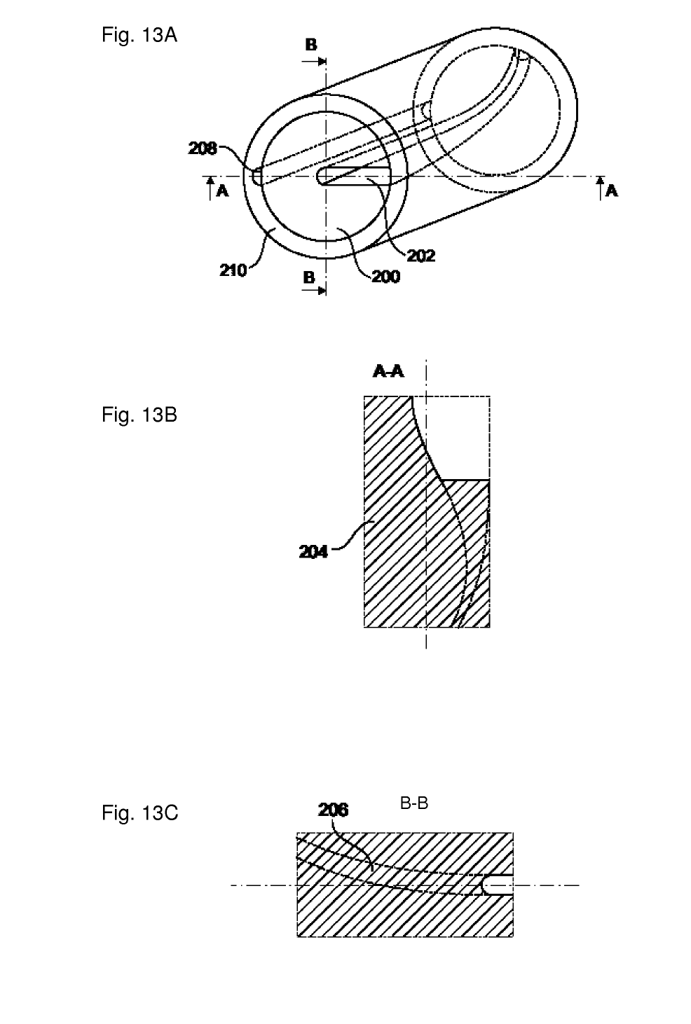

If this does not work a passive rotation device can be used, in fact the same principle as the spinning arm in U.S. Pat. No. 5,911,381. Only now the device is made simpler, see FIG. 13A. A massive cylinder 200 contains a slit 202. At the entrance this slit extends until the axis of the cylinder, allowing the module to enter in the centre. Moving forward (direction container) the slit becomes less deep until it forms a channel at the surface of the cylinder. This transition is shown in cross-sectional view in A-A direction at hatched section 204 in FIG. 13B. When the channel is at the surface there is a transition from a straight channel to a helical channel, see also projected channel 206 cross-sectional view in B-B direction in FIG. 13C. When the first part of the loop is obtained it can be inserted with one branch in the slit 202 and channel 206. Then the cylinder and loop of module are sleeved by a pipe section 210 (section of the funnel), the second branch of the loop placed in straight slit 208. When placed in the funnel cylinder 200 will rotate in pipe section 210, driven by the module that is inserted. In order to lock cylinder 200 in axial direction the internal diameter of the other sections of the funnel are a little less in diameter than that of pipe section 210. Uses of special materials, like Teflon, are preferred to obtain a low rotational friction. It is also preferred to center the module when entering the rotating cylinder 200. This can be done by placing the rotation device immediately after drive wheel 20 and upper press wheel 22 (when possible) or by placing plates 112 and 116 from FIG. 12 just before the rotational device.

In FIG. 14 the friction of the rotating device (cylinder 200 with slit 202 and helical section 206 of that slit) has been further diminished by putting it on ball bearings 212. Now there can be a small gap (just enough to not touch and not have friction, but amply enough to avoid that module 80 can come in between) between cylinder 200 and pipe section 210. In this embodiment the ball bearings are placed on a tapered (conical) central bottom 214 of the container 24. Also the top of the container can contain a tapered section 216. Note that it shall be possible to remove funnel 26 with pipe section 210 (mounting means not shown) from the container with mounted cylinder 200, in order to be able to pass the loop 82 of module 80.

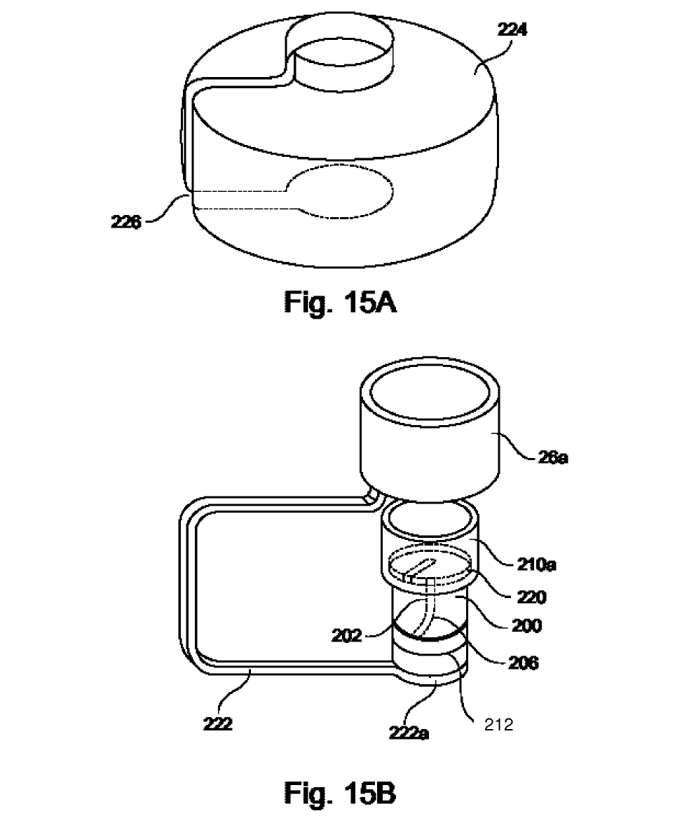

In FIGS. 15A and 15B a variant of FIG. 14 is shown in which mounting is made easier. Here pipe section 210a does not contain a slit 208 to let pass one part of the loop of module 82. Instead said part of the loop is now outside pipe section 210a. For this the outer diameter of pipe section 210a is sufficiently smaller than the inner diameter of funnel part 26a, such than the cylinder 200 with pipe section 210a runs free from said funnel part, also when said part of the loop is in between them. When the other part of the loop of module is inserted in slit 202 it can be locked in the centre of cylinder 200 by rotating circular plate 220, which has the same function as indicated in FIG. 12. Next said part of the module is guided in helical part 206 of slit 202 and locked by sliding pipe section 210a down (leaving a side-opening of helical part 206 of slit 202).

Cylinder 200 with pipe section 210 rotates on ball-bearing 212 and may also be mechanically driven (electronic- or air-motor, not shown in Figure) with a very small torque in the direction of pushing the module out of helical part 206 of slit 202 into the container. This will keep the module coiling against the outer wall of the container, especially important when uncoiling, avoiding “pulling small loops” when the module lacks stiffness. Ball-bearing 212 is mounted on circular plate 222a, which is a part of the strip 222 that connects to funnel 26a. This allows mounting the funnel with rotatable cylinder 200 on the tool, leaving enough space to access and perform the handlings described above. When done the container 224 is sliced onto the funnel 26a. Slit 226 allows to pass strip 222 and rotatable cylinder 200 (with other parts) when doing so, and strip 222 becomes an integral part of the container. Note that it is useful to clip (not shown) loop 82 of the module onto the upper part of strip 222, to avoid uncontrolled spinning of cylinder 200 by the mechanical drive at the end of the uncoiling process. This clipping on shall be done in a way not to hinder coiling of the loops and with some rounding of guiding to avoid kinking of the module when pulling the loop away.

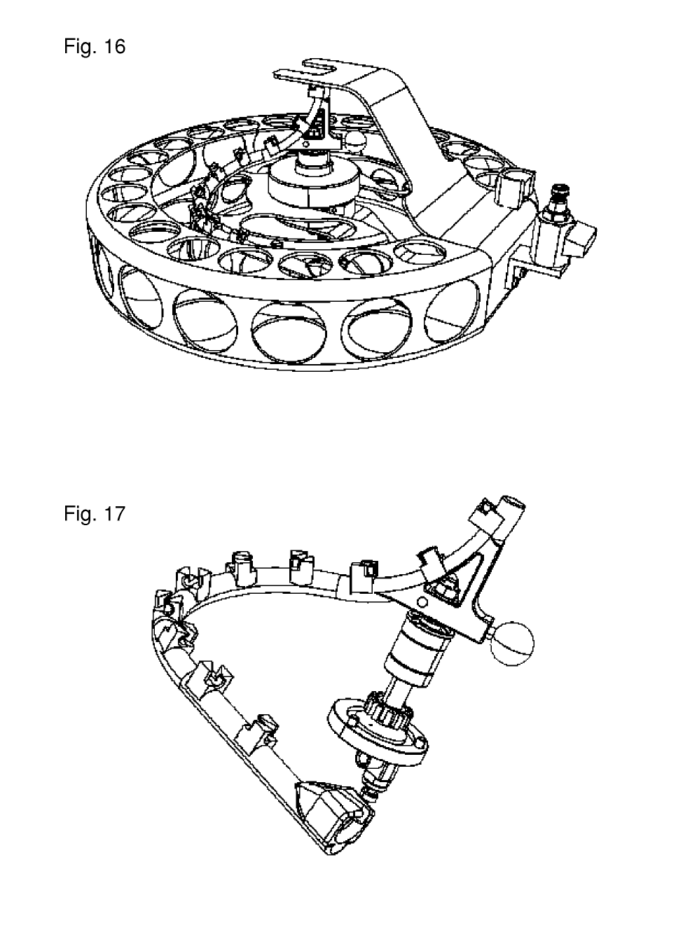

In FIG. 16 another variant is shown of the container and with a spinning arm like used in U.S. Pat. No. 5,911,381. Here an air motor is used to move the spinning arm. In FIG. 17 a detailed view of the spinning arm with air motor is shown. Besides the container and clamping device, also the housing of the motor is taken away for clarity. The gear wheel shown on the axis catches the air that comes through the air-connection at the bottom. Inside the housing of the motor (hided in FIG. 17) the air is directed to blow against this gear wheel in tangential direction, and in a direction such that the spinning arm “pushes” the module.

Pulling out (retracting) the module from the cable might be enhanced by using air blowing (from the far end) or air suction (from the tool). In the latter case the tool must be made such that it encloses fully the window in the cable, and air suction channels and connections must be made in the housing of the tool (not shown). When the retractable cable is built with separate loose tubes with modules the suction “mouth” is easily connected on said loose tubes. For air blowing assistance (from any suitable far end where the modules are cut and compressed air connected) a compressor or gas bottle with remote controlled valve might be used. To avoid uncontrolled blowing out of the module the free capstan part of the drive wheel might be covered with a “lid”, with a gap small enough to avoid the module from popping out, and large enough not to touch the drive wheel and allowing enough free space for the module. In the latter case the process of blowing out is only done for the length needed to branch. The module may then be cut again, leaving a remaining “blow out length” of module in the cable. The invention is not limited to the tool and cables as described here. For example, instead of loose coiling the modules in a container also coiling around a reel can be done, like is done with casting rods and described in e.g. U.S. Pat. No. 2,648,505. In this case the type with a stationary non-rotary drum or spool is meant.

1. An apparatus for retracting, storing and inserting an elongated element, the apparatus comprising:
a retracting unit for retracting a length of a pre-cut module through a window of a retractable cable;
a storing unit for storing the retracted pre-cut module; and
an inserting unit for inserting the retracted pre-cut module into a branch duct;
wherein the retracting unit, the storing unit, and the inserting unit being are mounted on an assembly portion installed at a branch location.

2. The apparatus of claim 1, wherein the assembly portion is placed in a tapping box installed around the retractable cable at a branch location.

3. The apparatus of claim 1, wherein the comprises:
a drive wheel;
an upper press wheel spring loaded against the drive wheel; and
a motorized unit connected to an axis of the drive wheel exerting a first pulling force on the retracted pre-cut module.

4. The apparatus of claim 3, wherein the pre-cut module is conducted around a periphery of the drive wheel according to an angular section before being pressed by the upper press wheel against the drive wheel, enabling extra pushing force by a capstan effect.

5. The apparatus of claim 1, wherein the storing unit comprises:
a container; and
a funnel having a first extremity comprising a spherical ball body, a difference between an internal diameter of the funnel and an external diameter of the spherical body determined to let the module pass, a second extremity of the funnel being connected to the container.

6. The apparatus of claim 1, wherein the inserting unit means comprises:
said a drive wheel;
a lower press wheel spring loaded against the drive wheel;
a guiding unit means for guiding the pre-cut model from the drive wheel to an inlet of the branch duct; and
a motorized unit connected to an axis of the drive wheel exerting a second pushing force on the retracted pre-cut module.

7. The apparatus of claim 6, wherein the pushing force is lower than a pulling force.

8. The Apparatus of claim 7, wherein the motorized unit comprises a magnetic clutch.

9. The apparatus of claim 6, wherein the drive wheel comprises a first peripheral surface comprising U-groove cooperating with the upper press wheel for pulling the retracted pre-cut module and a second peripheral surface for pushing the retracted pre-cut module in the branch duct wherein the first and the second peripheral surfaces are disposed side by side.

10. The apparatus of claim 9, wherein the inserting unit further comprises pressurized air flow inlet for pushing the retracted pre-cut module in the branch duct.

11. The apparatus of claim 6, wherein the storing unit comprises a container and a funnel having a first extremity comprising a spherical ball body, a difference between an internal diameter of the funnel and an external diameter of the spherical body determined to let a module pass, the second extremity of the funnel connected to the container; and
the spherical body is activated in a radial direction via a crank connected to the upper press wheel, for pressing and holding the module when the last leaves the space between the upper press wheel and the drive wheel.

12. The apparatus of claim 6, further comprising at least another channel for at least one previously installed module.

13. The apparatus of claim 6, wherein the storing unit comprises a container and a funnel having a first extremity comprising a spherical ball body, a difference between an internal diameter of the funnel and an external diameter of the spherical body determined to let a module pass, the second extremity of the funnel connected to the container; and
the container comprises an arranging unit for a proper arrangement of the pre-cut module into the container.

14. An apparatus for retracting, storing and inserting an elongated element, the apparatus comprising:
a retracting unit for retracting a length of a pre-cut module through a window of a retractable cable;
a storing unit for storing the retracted pre-cut module, the storing unit comprising a container and a funnel having a first extremity comprising a spherical ball body, a difference between an internal diameter of the funnel and an external diameter of the spherical body determined to let a module pass, the second extremity of the funnel connected to the container, the container comprising an arranging unit for a proper arrangement of the pre-cut module into the container; and
an inserting unit for inserting the retracted pre-cut module into a branch duct;
wherein the retracting unit, the storing unit, and the inserting unit are mounted on a assembly portion installed at a branch location.

15. The apparatus of claim 14, wherein the inserting unit comprises:
a drive wheel;
a lower press wheel spring loaded against the drive wheel;
a guiding unit for guiding the pre-cut model from the drive wheel to an inlet of the branch duct; and
a motorized unit connected to an axis of the drive wheel exerting a second pushing force on the retracted pre-cut module.

16. The apparatus of claim 15, wherein the second pushing force is lower than the pulling force.

17. The apparatus of claim 16, wherein the motorized unit comprises a magnetic clutch.

18. The apparatus of claim 15, wherein, the drive wheel comprises a first peripheral surface comprising a U-groove cooperating with the upper press wheel for pulling the retracted pre-cut module and a second peripheral surface for pushing the retracted pre-cut module in the branch duct, wherein the first and the second peripheral surfaces are disposed side by side.

19. The apparatus of claim 18, wherein the inserting unit further comprises a pressurized air flow inlet for pushing the retracted pre-cut module in the branch duct.

20. The apparatus of claim 15, wherein the spherical body is activated in a radial direction via a crank connected to the upper press wheel, for pressing and holding the module when the last leaves the space between the upper press wheel and the drive wheel.
